(19) United States
(12) Patent Application Publication
(10) Pub. No.: US 2026/0031067 A1
(43) Pub. Date: Jan. 29, 2026

(54) SLIDER FOR STRINGED INSTRUMENT

(71) Applicant: e-nextVision LLC, Shimane (JP)

(72) Inventor: Takeharu KODAKI, Shimane (JP)

(21) Appl. No.: 18/997,850

(22) PCT Filed: Nov. 24, 2023
(86) PCT No.: PCT/JP2023/042227

§ 371 Date: Jan. 23, 2025

(30) Foreign Application Priority Data
Nov. 24, 2022 (JP) 2022-187145

(51) Int. Cl. G10D 3/173

(52) U.S. Cl. CPC G10D 3/173

(57) ABSTRACT

The present invention addresses the problem of providing a slider for a stringed instrument to ensure that improved sound quality and smooth slide operation are realizable when sliding in slide playing on the stringed instrument. This slider for the stringed instrument is provided with a portion to be held that is held by a finger, and a pressing portion that is supported on the portion to be held side and made to move in press contact with strings of the stringed instrument toward a string direction, the pressing portion being supported rotatably and configured to have an annular outer peripheral surface around a rotation axis of the pressing portion. The outer peripheral surface forms a press contact surface that is made in press contact with the strings, and the portion to be held is held by the finger pressing down the strings, with a neck of the stringed instrument grasped.

### TECHNICAL FIELD

This invention relates to a slider for a stringed instrument for use when performing slide playing on the stringed instrument such as mainly guitars.

### BACKGROUND ARTS

Conventionally, as for one technique for slide playing on a stringed instrument such as guitars, it is publicly known that a cylindrical member made of metal, glass, plastic or like material is fitted to the little finger and/or ring finger pressing down strings, or a pressing bar and/or contact member that makes contact with the strings is attached to the outer peripheral part of a cylindrical insertion portion, as disclosed in the following Patent Documents 1 to 3, for instance.

### PRIOR ART DOCUMENTS

### Patent Documents

Patent Document 1: Japanese Unexamined Patent Application Publication No. 2012-14132
Patent Document 2: Japanese Utility Model Registration Publication No. 3235946
Patent Document 3: Japanese Unexamined Patent Application Publication No. 2008-96643

### SUMMARY OF THE INVENTION

### Problem to be Solved by the Invention

However, a conventional slide bar is made to slide in press contact with the strings, and accordingly, a slide noise would be more or less produced during playing on the stringed instrument, thus causing the problem of difficulty in making mellifluous and/or deep sound alteration. In general, while such slide noise would differ in its loudness and/or properties according to not only the material and/or cross-sectional shape of the pressing bar serving as one constituent of the slide bar, but also the surface irregularities and/or material of each string itself, it is considered that a level of this noise would be more increased as the friction between the pressing bar and the strings becomes larger, and also that the force of friction therebetween would vary depending on the degree to which the strings are pressed down with the player's fingers.

### Means for Solving the Problem

To solve the above problem, a slider for a stringed instrument according to the present invention comprises a portion to be held that is held by a finger, and a pressing portion that is supported on the portion to be held side and made to move along a string direction in press contact with strings of the stringed instrument, wherein the pressing portion is supported rotatably and configured to have an annular outer peripheral surface around a rotation axis of the pressing portion, and the outer peripheral surface forms a press contact surface that is made in press contact with the strings.

The portion to be held may be configured to be held by the finger pressing down the strings, with a neck of the stringed instrument grasped.

The portion to be held may form a portion to be fitted that is fitted to the finger.

The portion to be fitted may form an insertion portion into which the finger is inserted.

The insertion portion may be in the form of one or more cylindrical members with at least each one end open to ensure that the finger pressing down the strings is removably made insertable thereinto.

The cylindrical members may be paired together to ensure that two fingers pressing down the strings are made insertable thereinto each separately, and the pressing portion may be arranged on the string pressing-down side in between the pair of cylindrical members, in a state where the rotation axis of the pressing portion is directed toward a direction along the cylindrical members.

The pressing portion may be arranged on the string pressing-down side of the portion to be held, the pressing portion being rotatably supported on a body frame that is attached to the portion to be held.

The body frame may be configured to have a pair of bearing portions, and the pressing portion may be rotatably supported by the pair of bearing portions through bearings. The body frame may be formed integrally with the portion to be held.

The portion to be held may be formed in a direction along the finger, and the pressing portion may be arranged such that the rotation axis of the pressing portion is in a twisted position with respect to the direction where the portion to be held is formed.

The outer peripheral surface of the pressing portion may be in a circular ring shape with the rotation axis of the pressing portion as a center, as viewed in the axial direction of the rotation axis thereof.

The pressing portion may be in the form of a roll-shaped or cylindrical pressing bar that extends in the direction of the rotation axis.

The portion to be held may form a grip portion that is gripped by the fingers.

The grip portion may be configured to have a recessed portion to which the finger pressing down the strings is partly hooked, with the neck of the stringed instrument grasped.

The grip portion may be configured to have a pair of the recessed portions that are gripped and held by two fingers.

The recessed portion may be in the form of a concave surface that is dented in a circular arc shape in cross section and extends along the finger.

The portion to be held may be formed in a direction along the finger, and the pressing portion may be supported on the portion to be held side, in a posture where the rotation axis of the pressing portion extends along the portion to be held.

The portion to be held may be in the form of a single cylindrical member with at least one end open to ensure that the finger is removably made insertable thereinto, and the pressing portion may be in the form of a roll-shaped pressing bar that is larger in diameter than the cylindrical member and coaxial with the cylindrical member, the pressing bar being rotatably supported on the outer peripheral surface part of the cylindrical member, with the cylindrical member at least partly housed in the inner peripheral surface part of the pressing bar.

### Effects of the Invention

With the present invention configured as described above, the pressing portion made in press contact with the strings during slide playing by the player of the stringed instrument such as guitars is rotationally moved in accordance with the amount of slide, thus resulting in that the noise caused by friction between the strings and the pressing portion can be largely reduced to ensure that mellifluous and deep sound alteration is realizable and also that the frictional wear on the strings and/or the strain on the player's fingers can be reduced.

### BRIEF DESCRIPTION OF THE DRAWINGS

FIG. 1 is a front perspective view showing a state in which a slide bar with the present invention applied is in use.

FIG. 2 is an exploded perspective view of the slide bar.

FIG. 3 is a perspective view showing the configuration of a main part of the slide bar in an assembled state.

FIGS. 4(A) and 4(B) are respectively a bottom view and a right-side view of a body portion of the slide bar.

FIGS. 5(A) and 5(B) are respectively a bottom view and a left-side view of a tip end-side bearing portion.

FIG. 6 is an exploded cross-sectional view showing a state in which a bearing, a housing and a bearing portion are assembled one another.

FIG. 7 is a side view of a slide bar according to another embodiment

FIG. 8 is a perspective view of a main part of the slide bar shown in FIG. 7.

FIGS. 9(A) and 9(B) are cross-sectional views respectively showing different embodiments of a structure for supporting a pressing bar.

FIG. 10 is a perspective view of a main part of a slide bar according to still another embodiment.

FIG. 11 is a side view of the slide bar according to the still another embodiment.

FIG. 12 is a side view of a slide bar according to yet another embodiment.

FIG. 13 is a perspective view of a main part of a slide bar according to yet another embodiment.

FIG. 14 is a cross-sectional view of a slide bar according to yet another embodiment.

### MODE FOR EMBODYING THE INVENTION

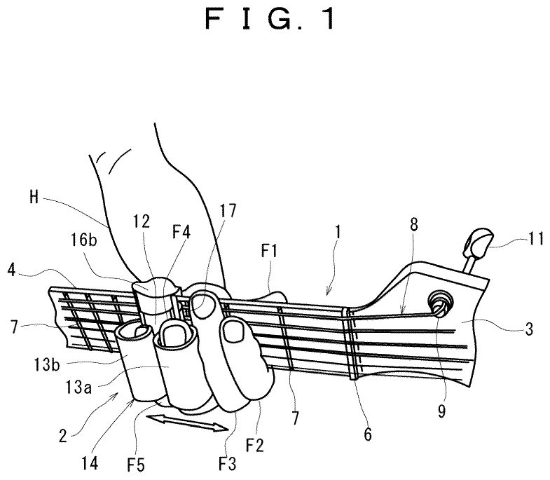

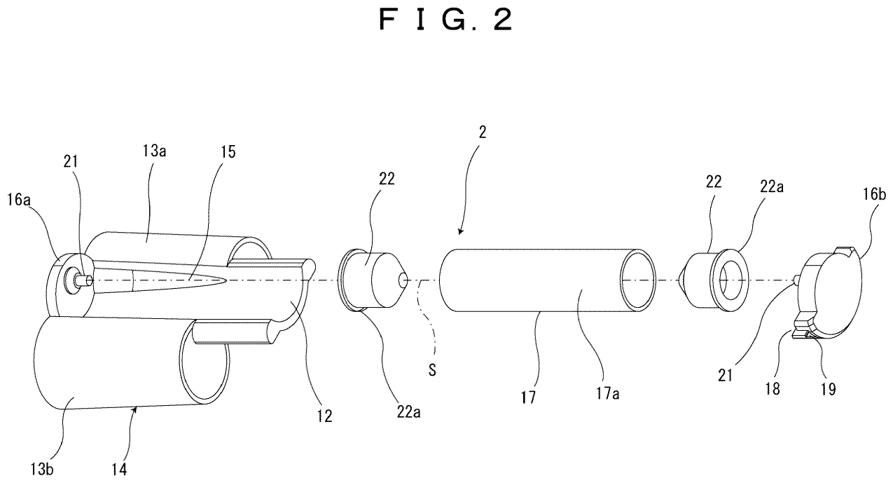

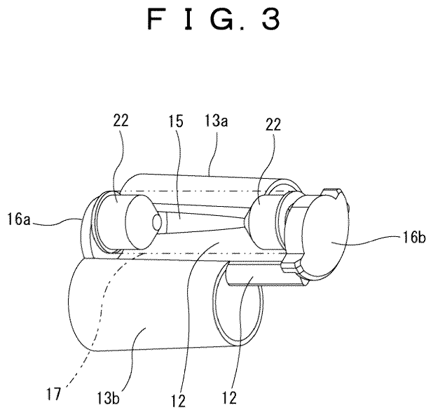

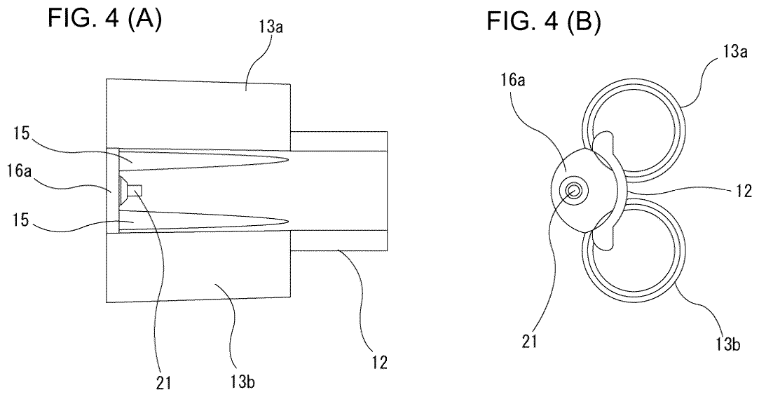

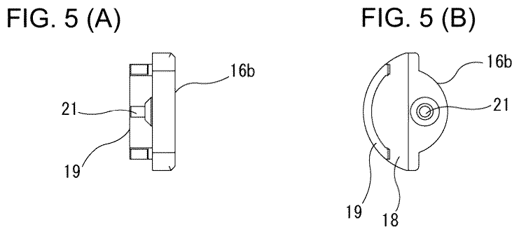

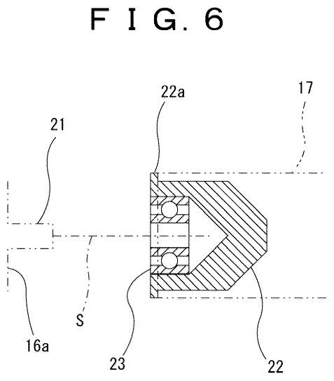

FIG. 1 is a front perspective view showing a state in which a slide bar with the present invention applied is in use, FIG. 2 is an exploded perspective view of the slide bar, FIG. 3 is a perspective view of the configuration of a main part of the slide bar in an assembled state, FIGS. 4(A) and 4(B) are respectively a bottom view and a right-side view of a body portion of the slide bar, FIGS. 5(A) and 5(B) are respectively a bottom view and a left-side view of a tip end-side bearing portion, and FIG. 6 is an exploded cross-sectional view showing a state in which a bearing, a housing and a bearing portion are assembled one another.

It is noted that a slide bar (slider for stringed instrument, rolling slider for stringed instrument) 2 is used in an obliquely tilted posture along the stretching direction of fingers F4, F5, as shown in FIG. 1. It is also noted that the following description will be given on the premise that front-and-rear, left-and-right and up-and-down directions are specifically defined for the sake of convenience, basically provided that the stretching direction of the fingers F4, F5 shall be the left-and-right direction, and the direction to press down the strings by a player shall be a downward direction.

Referring to a guitar (stringed instrument) 1, a neck 4 between a guitar head 3 and a guitar body (not shown) has, on its surface, a nut 6 that is installed in a direction crossing the head 3-side body part, and the nut 6 is followed by a large number of frets 7 that are arranged in an embedded state at prescribed intervals. Strings 8 including the first to sixth strings are tensely provided on the upper surface side of both the nut 6 and the frets 7 so as to extend along the longitudinal direction of the neck 4, and each string 8 is tensed and tuned on its head 3-side by a string post 9 and a tuning peg 11 that is connected to the string post.

In this embodiment, as is commonly considered to be so, the slide bar 2 is a type of slider for the stringed instrument of the present invention and shall be used in a manner of being removably fitted to two fingers, namely, the ring finger and little finger F4, F5 with the exception of the thumb, index finger and middle finger F1, F2, F3, of one hand H, specifically, the hand that is put on the side to press down the strings, of the player who is playing the guitar 1, and during slide playing, the position of the slide bar is made to move along the string direction, while the strings 8 are being pressed down.

As shown in FIG. 2, the slide bar 2 has a cylindrical piece-shaped body frame 12 that is configured to have a circular arc concave surface on the string pressing-down side, and a body portion 14 that is configured to have integrally-formed (integrated in the embodiment shown) insertion portions (portions to be held, portions to be fitted) 13a, 13b that are respectively in the form of cylindrical members attached in parallel to both the left and right sides of the body frame 12, the insertion portions being fitted to the two fingers F4, F5 by inserting these fingers F4, F5 thereinto each separately. It is noted that the fingers F1, F2, F3, F4, F5 to be inserted into the insertion portions 13a, 13b are not limited to the two fingers, namely, the ring finger and little finger F4, F5, but insertion of one or more other fingers F1, F2, F3 may be permitted.

The insertion portions 13a, 13b are each in a cylindrical shape whose at least one end is open to ensure that the fingers F4, F5 are removably made insertable thereinto. In regards to each of the insertion portions, its one end that is open to allow for insertion of the finger F4 or F5 shall be a base end, and the end opposite thereto shall be a tip end. In the embodiment shown, the tip end of each of the insertion portions 13a, 13b is also open, and accordingly, the fingers F4, F5 respectively inserted into the insertion portions 13a, 13b from their open base ends are supposed to be in a state where their fingertips are respectively protruding outwards from the open tip ends of the insertion portions 13a, 13b (see FIG. 1).

Furthermore, the insertion portions 13a, 13b are each formed in a tapered shape with its diameter decreased gradually and slightly from the base end toward the tip end to ensure that the insertion and removal of the fingers F4, F5 are made easier and also that the player may surely feel the sense of fitting in close contact with one's fingers F4, F5. In other words, the insertion portions 13a, 13b are each formed in a truncated cone shape with both ends open.

Meanwhile, the body frame 12 has, on its base end side, a slit 15 for making the body portion lightweight and also for preventing the inserted fingers from being sweated and so on (see FIG. 4).

While the insertion portions 13a, 13b are each in the form of the cylindrical member whose axial cross section forms a circular ring shape as described above, it is considered that this cylindrical member may be formed in a C-shape in cross section with a slit formed over the whole length in the axial direction in the part on the side opposite to the string pressing-down side and extends in the above axial direction. In this connection, the slit 15 may be omitted for improvement of sound quality.

The body frame 12 has, at its base end and tip end on the string pressing-down side, protrusive bearing portions 16a, 16b that are facing each other in a standing upright posture, and both ends of a pressing bar (pressing portion) 17 in the form of a roll-shaped cylindrical member are rotatably supported between the bearing portions 16a, 16b. In the embodiment shown, while use is made of stainless steel as the material for constituting the pressing bar 17, it is considered that use of other kinds of metals may, of course, be permitted, or alternatively, other kinds of materials such as hard plastic, glass and porcelain may also be applied to form the pressing bar 17. By the way, use of a hard material to constitute the pressing bar 17 ensures that sufficiently lingering and/or vibrant sound quality is realizable.

As long as the pressing portion 17 has a circular ring-shaped outer peripheral surface 17a with a rotation axis S of the pressing portion (see FIG. 2) as a center, as viewed in the axial direction of the rotation axis S, it is neither necessary for the pressing portion to be formed in a roll shape (more specifically, a cylindrical shape with both ends open) nor to be in the form of a bar member, and accordingly, the pressing portion may be formed in a spherical or columnar shape, for instance. By the way, this outer peripheral surface 17a shall form a press contact surface that is made in press contact with the strings 8.

The cylindrical piece-shaped body frame 12 in the body portion 14 and the pair of insertion portions 13a, 13b arranged substantially parallel to each other on both sides of the body frame 12 in the width direction are integrally formed (integrated in the embodiment shown) by using a plastic molding material.

The body frame 12 has, at its base end on the string pressing-down side, namely, the end on the side opposite to the fingertip side of the fingers F4, F5 respectively inserted into the insertion portions 13a, 13b, the integrally-formed (integrated in the embodiment shown) bearing portion (base end-side bearing portion) 16a formed in a plate shape and protruding toward the string pressing-down side. Meanwhile, the tip end of the body frame 12 on the string pressing-down side, namely, the end on the fingertip side of the fingers F4, F5 respectively inserted into the insertion portions 13a, 13b, protrudes further than the tip end of each of the insertion portions 13a, 13b both extended to the same extent, wherein the bearing portion (tip end-side bearing portion) 16b formed in a plate shape separately from the body frame 12 is protrusively provided at the protrusive tip end of the body frame such as to be opposite and parallel or substantially parallel to the base end-side bearing portion 16a, through the process of being inserted and fitted to this protrusive tip end.

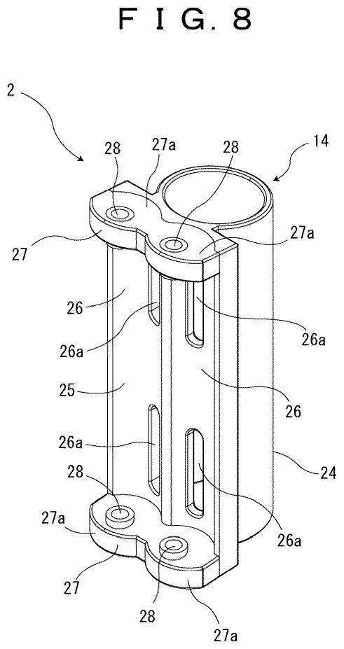

The tip end-side bearing portion 16b is formed by plastic molding and has, on its inner surface-side lower half part, a receiving groove 18 that is configured of a recessed groove directed outwards (toward the tip end) to receive both the inserted and fitted left and right sides of the protrusive tip end of the body frame 12, and the receiving groove 18 has, on its underside, an inwardly protrusive cylindrical guide piece 19 that guides the tip end of the body frame 12 in the process of being inserted, and then holds an inserted state along the upper surface (outer surface) of the inserted tip end of the body frame after insertion (see FIG. 8).

The pair of bearing portions 16a, 16b respectively have, on their inner surfaces (confronting surfaces), protrusive shaft portions 21, 21 that pivotally support the pressing bar 17. It is noted that the pair of shaft portions 21, 21 are, of course, coaxial with the rotation axis S. Between each shaft portion 21 and both ends of the pressing bar 17, there are deep dish-shaped housings 22 with flanges 22a respectively fitted to both ends of the pressing bar 17 and each made of a member having a certain degree of elasticity, and bearings 23 each having an outer ring elastically fitted into each housing 22 and an inner ring fitted onto each shaft portion 21, wherein the housings and the bearings are interposed therebetween in an assembled state (see FIG. 6), thus ensuring that the pressing bar 17 is smoothly made rotatable through the bearings 23.

The tip end-side bearing portion 16b is inserted and fitted to the tip end of the body frame 12 when assembling the pressing bar 17 fitted with the bearings 23 to the body frame 12, in which case, it is desirable to fixedly hold an overall assembled state by fixing the tip end-side bearing portion to the body frame 12 using adhesion or like other methods in the process of inserting and fitting the tip end-side bearing portion to the tip end of the body frame.

As shown in FIG. 4, the body portion 14 is placed in a condition where the cylindrical piece-shaped body frame 12 is located in the same direction as the body portion such as to be closer to the string pressing-down side in between the two insertion portions 13a, 13b arranged in parallel with prescribed spacing, and further, the shaft portion 21 (axial center of a roller) is provided in the center such as to be closer to the string pressing-down side. Therefore, when pressing down the strings during playing, the strings are surely pressed down at their center positions with the two fingers, thus ensuring that the strain on the fingers is reduced and also that the slide operation is made easier.

While the insertion portions 13a, 13b are normally in the form of two cylindrical members to ensure that the ring finger and little finger with exception of at least the thumb and index finger as shown in FIGURES are made insertable thereinto, it is considered that the number of cylindrical members may be reduced to one and/or the insertion portions may be each formed in a ring shape or a cylindrical piece shape with a C-shaped cross section, as long as the fingers are made insertable thereinto.

It is considered also that the slide bar 2 may be formed asymmetrically in the front-and-rear direction, provided that either one of the insertion portions 13a, 13b is omitted.

While the two insertion portions 13a, 13b are provided in the above embodiment, it is considered that there may be three or more insertion portions.

Furthermore, the fingers to be respectively inserted into the insertion portions 13a, 13b during playing are not limited to the ring finger and little finger F4, F5, but insertion of other fingers F1, F2, F3 may be permitted. Otherwise, in a situation where the guitar 1 is placed on the seat of a chair or like placement surface, for instance, without being held with the hand H of the player, it may be also possible for the player to play the guitar 1 while holding only the slide bar 2 with one's hand H.

Moreover, while the above embodiment shows that the outer peripheral surface of the pressing bar 17 is in the circular shape with the rotation axis S as the center, as viewed in the axial direction of the rotation axis S, it is considered that the pressing bar may have an outer peripheral surface that is formed in other shapes such as a polygonal shape that forms a ring in the direction around the rotation axis S, an elliptical shape and a somewhat distorted circular shape, provided that the pressing bar is surely made rotatable.

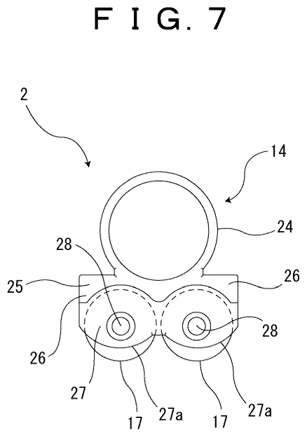

Next will be described another embodiment of the present invention in terms of some differences from the above embodiment with reference to FIGS. 7 to 9.

FIG. 7 is a side view of a slide bar according to another embodiment, and FIG. 8 is a perspective view of the configuration of a main part of the slide bar shown in FIG. 7. The body portion 14 of the slide bar 2 shown in FIGS. 7 and 8 has integrally (as an integral part in the embodiment shown) a single insertion portion (portion to be held, portion to be fitted, cylindrical member) 24, and a body frame 25 that supports a pair of pressing bars 17, 17 all at once.

The body frame 25 has integrally a pair of support portions 26, 26 that are provided for each pair of pressing bars 17, 17. The pair of support portions 26, 26 are formed in the left-and-right direction such as to be parallel to each other in side-by-side arrangement in the front-and-rear direction. Each support portion 26 has the same or substantially same configuration as the body frame 12 in the above embodiment. The pair of pressing bars 17, 17 are supported, in a mutually parallel posture, rotatably on the corresponding support portions 26, 26.

There is the above-described insertion portion 24 integrally (as an integral part in the embodiment shown) at the body frame part on the side opposite to the string pressing-down direction in between the pair of support portions 26, 26. This insertion portion 24 is cylindrically formed in a direction along both the pair of pressing bars 17, 17 and the pair of support portions 26, 26 (specifically, in the left-and-right direction parallel to both the pressing bars 17, 17 and the support portions 26, 26).

The insertion portion 24 is the same or substantially same in overall length as the body frame 26, 26 and also in alignment or substantially alignment in both open ends with the body frame 26, 26. Thus, one or two fingers F4, F5 are made insertable into the insertion portion 24 even from either of the two open ends thereof, thereby allowing the slide bar 2 to be fitted to the fingers F4, F5.

The body frame 25 has integrally, at its each end in the overall length direction (left-and-right direction), a bearing unit portion 27 that protrudes toward the string pressing-down direction. Each bearing unit portion 27 has integrally a pair of bearing portions 27a, 27a that are provided for the respective pressing bars 17, 17. In other words, one bearing unit portion 27 is configured of the pair of bearing portions 27a, 27a. Meanwhile, each support portion 26 has, at its recessed bottom-side part, more than one lightening holes 26a, 26a (two lightening holes in the embodiment shown), each of which is in the form of an elongated hole extending in the overall length direction of each support portion.

Attachment of the pressing bar 17 to the support portion 26 in a removable manner may be performed by removably attaching and fixing one or both of the pair of bearing unit portions 27, 27 to the body frame 26, or alternatively, by attaching and supporting the pressing bars 17, 17 to the body frame 26, followed by fixing each of the bearing unit portions 27, 27 to the body frame 26 with an adhesive, etc.

The pair of bearing portions 27a, 27a provided at each support portion 26 have integrally, on their confronting surfaces, cylindrical support portions 28, 28 that support the pressing bar 17. Each support portion 28 is coaxial with the rotation axis S.

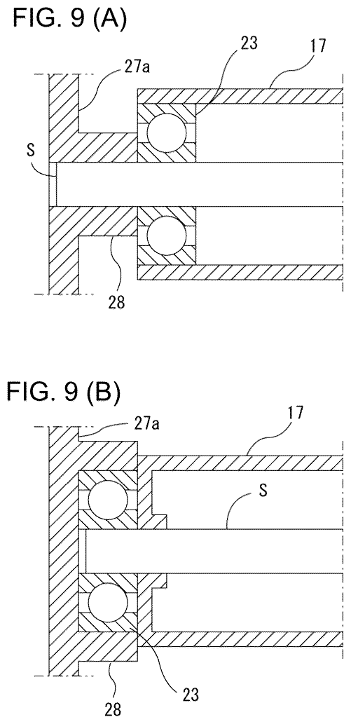

FIGS. 9(A) and 9(B) are cross-sectional views respectively showing different embodiments of a structure for supporting the pressing bar. In the embodiment shown in FIG. 9(A), the rotation axis S is fixedly installed between the pair of bearing portions 27a, 27a by a manner in which both ends of a support shaft physically provided to configure the rotation axis S are respectively and fittingly inserted toward the inner peripheral surface side of the pair of support portions 28, 28.

The bearing 23 is interposed between the outer peripheral surface of the rotation axis S and the cylindrical inner peripheral surface of the pressing bar with its axial center positioned on the rotation axis S, thus allowing the bearing 23 to support the pressing bar 17 rotatably on the rotation axis S.

Meanwhile, in the embodiment shown in FIG. 9(B), there are the bearings 23, 23 that are each interposed between each inner peripheral surface of the cylindrical support portions 28, 28 and the rotation axis S, thus allowing the bearings 23, 23 to support the rotation axis S to ensure that the bearing portions 27a, 27a are made rotatable. The pressing bar 17 is fixedly attached to the rotation axis S, in a state where the axial center of the pressing bar is positioned on the rotation axis S.

With the above configuration, use of more than one pressing bar 17 makes it possible to make a sound different from that obtained in use of the single pressing bar. Further, the slide bar 2 is formed symmetrically in the front-and-rear direction and in the left-and-right direction, so that even when using the slide bar with its left and right sides or front and rear sides replaced with each other, the player is allowed to perform playing with the same usability, and thus, a high degree of freedom on the posture of the slide bar 2 during its use is ensured. Besides, one end side of the pair of pressing bars 17, 17 is rotatably supported by the single bearing unit portion 27, and accordingly, it will be appreciated from this point of view that the slide bar configuration is prevented from being complicated.

In this connection, each end surface of the slide bar 2 of this embodiment in the axial direction (i.e., the left-and-right direction that is the overall length direction) of the rotation axis S forms a contact surface by a manner in which the outer surface of the bearing unit portion 27 is formed flush with the left-and-right directional end surface of the body portion 14 including the insertion portion 24 and the body frame 25. The pair of left and right contact surfaces are in the state of being tilted in a substantially inverted V-shape such that a distance between these contact surfaces gradually decreases toward the string pressing-down direction.

Therefore, as for the slide bar 2 held in the upright posture where its overall length direction is directed toward the up-and-down direction, placement of this slide bar on a horizontal placement surface in a state where one of the two contact surfaces is in contact with the placement surface results in that the slide bar 2 gets tilted slightly upwards toward the side opposite to the string pressing-down side. For that reason, in placement of the slide bar in the upright posture, more than one pressing bar 17 is operative so as to enable the reduction in a risk that the slide bar 2 with its center of gravity biased toward the string pressing-down side would be overturned.

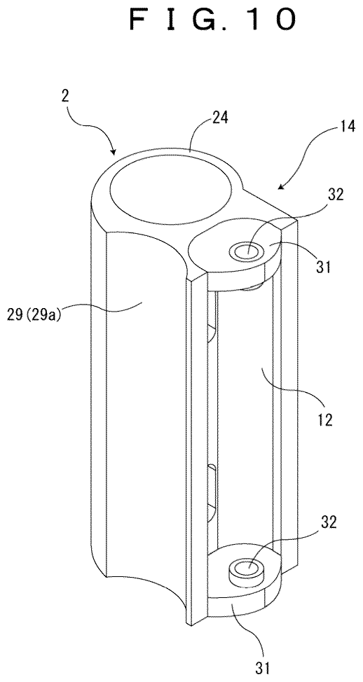

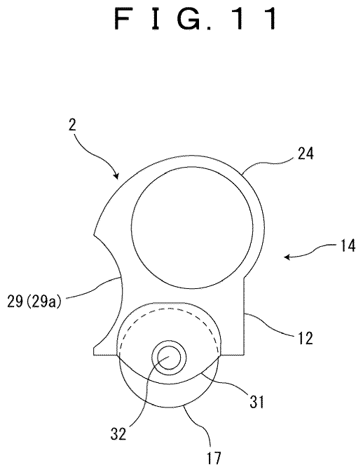

Next will be described still another embodiment of the present invention in terms of some differences from the above embodiments with reference to FIGS. 10 and 11.

FIGS. 10 and 11 are respectively a perspective view and a side view of the main part of a slide bar according to the still another embodiment. The body portion 14 of the slide bar 2 shown in FIGS. 10 and 11 has integrally a pair of portions to be held 24, 29 that are held by the fingers F4, F5, and a single body frame 12. The body frame 12 is the same or substantially same in overall length as the portions to be held 24, 29 and also in alignment or substantially alignment in both end positions in the overall length direction with the portions to be held. One of the pair of portions to be held 24, 29 forms the above-described insertion portion 24 into which the finger F4 or F5 is inserted, and the other forms a grip portion 29 that is gripped by the fingers F4, F5.

The body portion 14 has integrally, at its part on the string pressing-down side, the insertion portion 24 that is in the form of a cylindrical member with both ends open. The body portion 14 has integrally, at its part on the side opposite to the string pressing-down side, the single body frame 12. The body frame 12 in this embodiment has the same or substantially same configuration as the body frame in the embodiment shown in FIGS. 1 to 6.

A bearing portion 31 that is provided at each end of the body frame 12 in the overall length direction and protrudes toward the string pressing-down direction has the same or substantially same configuration as the bearing portion 27a in the embodiment shown in FIGS. 7 and 8. For that reason, each bearing portion 31 is configured to have integrally, on its inner surface, a cylindrical support portion 32. It is noted that one or both of the pair of support portions 32, 32 may be formed separately from the body frame 12 and then fixed to the body frame 12 with the adhesive, etc., similarly to the above embodiment, or alternatively, may be configured to be capable of being fixedly attached to the body frame in a removable manner.

The body portion 14 has, on its boundary between the insertion portion 24 and the body frame 12, a concave surface (recessed portion) 29a that is dented in a circular arc shape in cross section (as viewed in the axial direction of the rotation axis S in the embodiment shown) and extends in a direction (direction parallel to the rotation axis S in the embodiment shown) along the fingers F4, F5 that are to be held. At least a part of the grip portion 29 (the whole grip portion in the embodiment shown) is configured of the concave surface 29a.

When in use, one of the two fingers F4, F5 is stretchingly inserted into the insertion portion 24, while the other is partly (specifically, the side of the finger) and stretchingly hooked and held to the concave surface 29a so as to be housed therein.

With the above configuration, the portion to be held 29 may be configured of the concave surface 29a that is simpler in configuration than the insertion portion 24, thus allowing the configuration of the slide bar 2 to be simplified.

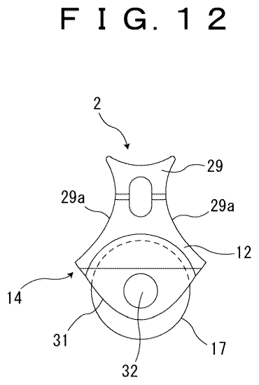

Next will be described yet another embodiment of the present invention in terms of some differences from the above embodiments with reference to FIG. 12.

FIG. 12 is a side view of a slide bar according to the still another embodiment. In the embodiment shown in FIG. 12, only the grip portion 29 is provided as the portion to be held. The grip portion 29 in this embodiment is formed integrally with a part (specifically, the half) of the body portion 14 on the side opposite to the string pressing-down side. The grip portion 29 has, on its front and rear surfaces respectively, a pair of concave surfaces 29a, 29a that are held between the two fingers F4, F5.

With the above configuration, use of only the grip portion 29 that is simpler in configuration than the insertion portion 4 makes it possible to hold the slide bar 2 with the fingers F4, F5, thus allowing the configuration of the slide bar 2 to be more simplified. Further, in this embodiment, the slide bar 2 is also symmetrically in the front-and-rear direction and in the left-and-right direction, and thus, a high degree of freedom on the posture of the slide bar during its use is ensured, similarly to the embodiment shown in FIGS. 7 and 8.

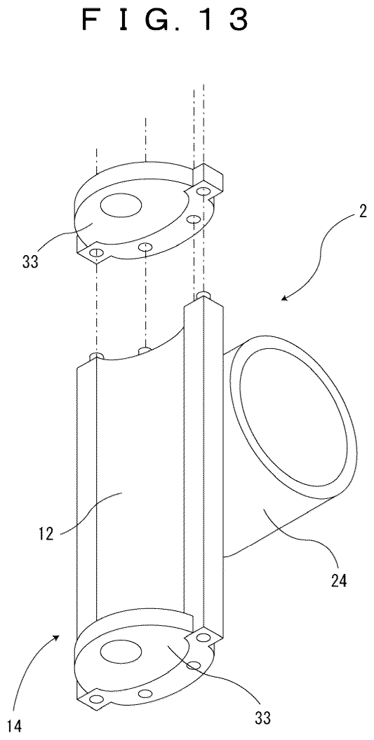

Next will be described yet another embodiment of the present invention in terms of some differences from the above embodiments with reference to FIG. 13.

FIG. 13 is a perspective view of the main part of a slide bar according to the yet another embodiment. While the above embodiments respectively show that the pressing bar 17 (rotation axis S) and the body frame 12 that supports the pressing bar 17 are formed in a direction parallel to (along) the portions to be held 13a, 13b, 24, 29 that are formed in a direction along the fingers F4, F5 (namely, the fingers in a stretching state) with the slide bar 2 held, it is noted that in this embodiment, the pressing bar and the body frame are arranged in a twisted position with respect to the portion to be held 24.

Specifically, the body frame 26 that supports the pressing bar 17 in a posture being directed toward its own overall length direction is formed integrally with the portion to be held 24 so as to be superposed thereon. In this case, the pressing bar 17 and the body frame 26 (rotation axis S) are supposed to be in the state of intersecting (more specifically, at right angles) with the portion to be held 24, as viewed in the superposing direction as described above (namely, in planar view).

The body frame 12 protrudes from the insertion portion 24 toward one side (specifically, forwards) in the intersecting direction as described above, and has respectively, at its both ends, bearing portions 33a, 33b. One of the bearing portions 33a, 33b forms a non-detachable bearing portion 33a that is integrally provided on the non-protruding side of the body frame 12, while the other forms a detachable bearing portion 33b that is detachably provided on the protruding side of the body frame 12. Each of the bearing portions 33a, 33b has the same or substantially same configuration as the bearing portions 16a, 16b described above.

With the above configuration, the player is allowed to perform playing with one's hand facing the direction different from that as shown in the above embodiments. In particular, it becomes easier for the player to perform playing on the guitar 1, when playing in the situation where the guitar 1 is placed on the placement surface without being held with one's hand H.

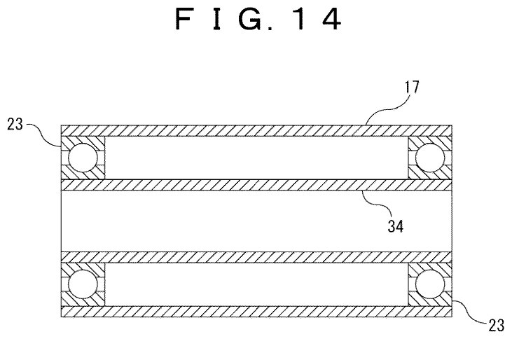

Next will be described yet another embodiment of the present invention in terms of some differences from the above embodiments with reference to FIG. 14.

FIG. 14 is a cross-sectional view of a slide bar according to yet another embodiment. In this embodiment shown in FIG. 14, the slide bar has a single cylindrical member 34 that is in a circular ring shape in cross section, and a roll-shaped pressing bar 17 that is larger in diameter than the cylindrical member 34 and coaxial with the cylindrical member 34, wherein with the cylindrical member at least partly (wholly in the embodiment shown) housed in the inner peripheral surface part of the pressing bar 17, the pressing bar 17 is supported rotatably on the outer peripheral surface part of the cylindrical member 34 through two or more bearings 23, 23 that are interposed between the pressing bar and the cylindrical member.

With the above configuration, a member such as the body frame 12 required for the above embodiments is omittable, thus allowing the slide bar configuration to be simplified to a considerable extent.

### EXPLANATION OF REFERENCE NUMERALS

1: Guitar (stringed instrument)
2: Slide bar (slider for stringed instrument, rolling slider for stringed instrument)
4: Neck
8: Strings
12: Body frame
13a: Insertion portion (portion to be held, portion to be fitted, cylindrical member)
13b: Insertion portion (portion to be held, portion to be fitted, cylindrical member)
16a: Base end-side bearing portion (bearing portion)
16b: Tip end-side bearing portion (bearing portion)
17: Pressing bar (pressing portion)
17a: Press contact surface (outer peripheral surface)
23: Bearing
24: Insertion portion (portion to be held, portion to be fitted, cylindrical member)
25: body frame
27a: Bearing portion
29: Grip portion (portion to be held)
29a: Concave surface (recessed portion)
31: Bearing portion
33a: Non-detachable bearing portion (bearing portion)
33b: Detachable bearing portion (bearing portion)
34: Cylindrical member (portion to be held, portion to be fitted)
F1: Thumb
F2: Index finger
F3: Middle finger
F4: Ring finger
F5: Little finger
S: Rotation axis

1. A slider for a stringed instrument comprising:
a portion to be held that is held by a finger; and
a pressing portion that is supported on the portion to be held side and made to move along a string direction in press contact with strings of the stringed instrument;
wherein said pressing portion is rotatably supported and configured to have an annular outer peripheral surface around a rotation axis of said pressing portion; and
said outer peripheral surface forms a press contact surface that is made in press contact with said strings.

2. The slider for the stringed instrument according to claim 1, wherein said portion to be held is configured to be held by the finger pressing down the strings, with a neck of said stringed instrument grasped.

3. The slider for the stringed instrument according to claim 1, wherein said portion to be held forms a portion to be fitted that is fitted to said finger.

4. The slider for the stringed instrument according to claim 3, wherein said portion to be fitted forms an insertion portion into which said finger is inserted.

5. The slider for the stringed instrument according to claim 4, wherein said insertion portion is in the form of one or more cylindrical members with at least each one end open to ensure that the finger pressing down the strings are removably made insertable thereinto.

6. The slider for the stringed instrument according to claim 5, wherein said cylindrical members are paired together to ensure that two fingers pressing down the strings are made insertable thereinto each separately, and said pressing portion is arranged on the string pressing-down side in between the pair of cylindrical members, in a state where the rotation axis of the pressing portion is directed toward a direction along said cylindrical members.

7. The slider for the stringed instrument according to claim 1, wherein said pressing portion is arranged on the string pressing-down side of said portion to be held, said pressing portion being supported rotatably to a body frame that is attached to said portion to be held.

8. The slider for the stringed instrument according to claim 7, wherein said body frame is configured to have a pair of bearing portions, and said pressing portion is rotatably supported by the pair of bearing portions through bearings.

9. The slider for the stringed instrument according to claim 7, wherein said body frame is formed integrally with said portion to be held.

10. The slider for the stringed instrument according to claim 7, wherein said portion to be held is formed in a direction along the finger, and said pressing portion is arranged such that the rotation axis of said pressing portion is in a twisted position with respect to the direction where said portion to be held is formed.

11. The slider for the stringed instrument according to claim 1, wherein the outer peripheral surface of said pressing portion is formed in a circular ring shape with the rotation axis of said pressing portion as a center, as viewed in the axial direction of said rotation axis.

12. The slider for the stringed instrument according to claim 11, wherein said pressing portion is in the form of a roll-shaped or cylindrical pressing bar that extends in the direction of said rotation axis.

13. The slider for the stringed instrument according to claim 1, wherein said portion to be held forms a grip portion that is gripped by the fingers.

14. The slider for the stringed instrument according to claim 13, wherein said grip portion is configured to have a recessed portion to which the finger pressing down the strings is partly hooked, with the neck of the stringed instrument grasped.

15. The slider for the stringed instrument according to claim 14, wherein said grip portion is configured to have a pair of said recessed portions that are gripped and held by the two fingers.

16. The slider for the stringed instrument according to claim 14, wherein said recessed portion is in the form of a concave surface that is dented in a circular arc shape in cross section and extends along said finger.

17. The slider for the stringed instrument according to claim 1, wherein said portion to be held is formed in a direction along the finger, and said pressing portion is supported on said portion to be held side, in a posture where the rotation axis of said pressing portion extends along said portion to be held.

18. The slider for the stringed instrument according to claim 17, wherein said portion to be held is in the form of a single cylindrical member with at least one end open to ensure that said finger is removably made insertable thereinto, and said pressing portion is in the form of a roll-shaped pressing bar that is larger in diameter than said cylindrical member and coaxial with said cylindrical member, said pressing bar being supported rotatably on the outer peripheral surface part of said cylindrical member, with said cylindrical member at least partly housed in the inner peripheral surface part of said pressing bar.

19. The slider for the stringed instrument according to claim 15, wherein said recessed portion is in the form of a concave surface that is dented in a circular arc shape in cross section and extends along said finger.
